(19) United States
(12) Patent Application Publication
(10) Pub. No.: US 2022/0294020 A1
(43) Pub. Date: Sep. 15, 2022

(54) METHOD FOR PRODUCING ELECTRODE

(71) Applicants: Prime Planet Energy & Solutions, Inc., Tokyo (JP); TOYOTA JIDOSHA KABUSHIKI KAISHA, Aichi-ken (JP)

(72) Inventors: Katsushi ENOKIHARA, Toyota-shi (JP); Naohiro MASHIMO, Toyota-shi (JP); Masanori KITAYOSHI, Toyota-shi (JP); Shou ISHIYAMA, Toyota-shi (JP)

(21) Appl. No.: 17/692,196

(22) Filed: Mar. 11, 2022

(30) Foreign Application Priority Data
Mar. 15, 2021 (JP) 2021-041750

(51) Int. Cl. H01M 10/0585; H01M 4/139; H01M 10/0525; H01M 4/04

(52) U.S. Cl. CPC H01M 10/0585; H01M 4/139; H01M 10/0525; H01M 4/0409

(57) ABSTRACT

Provided is a method for producing an electrode having an electrode active material layer in which the form of both edges is advantageously adjusted. A method for producing an electrode disclosed here is a method for producing an electrode which includes a long sheet-shaped electrode current collector of a positive electrode or a negative electrode; and a long sheet-shaped electrode active material layer formed on the electrode current collector. The method for producing an electrode includes the following steps: an electrode material preparation step for preparing an electrode material; a film formation step for forming a coating film in the sheet longitudinal direction on the electrode current collector using the electrode material; and a roller forming step for adjusting the form of both edge parts in the sheet longitudinal direction of the coating film using a forming roller.

### CROSS REFERENCE TO RELATED APPLICATIONS

The present application claims priority on the basis of Japanese Patent Application No. 2021-041750, which was filed on 15 Mar. 2021, and the entire contents of that application are incorporated by reference in the present specification.

### BACKGROUND

The present disclosure relates to a method for producing an electrode.

Secondary batteries such as lithium ion secondary batteries are lightweight and can achieve high energy densities, and can therefore be advantageously used as high output power sources for powering vehicles such as battery electric vehicles and hybrid electric vehicles, and demand for such secondary batteries is expected to increase in the future.

Examples of typical structures of positive electrodes and negative electrodes provided in this type of secondary battery (hereinafter, the term “electrode” is used in cases where no particular distinction is made between a positive electrode and a negative electrode) include structures in which an electrode active material layer comprising mainly an electrode active material is formed on one surface or both surfaces of a foil-like electrode current collector.

This type of electrode active material layer is typically formed by coating a surface of a current collector with a slurry-like (paste-like) electrode mixture (hereinafter referred to as a “mixture slurry”) prepared by dispersing solid components such as an electrode active material, a binder and an electrically conductive material in a prescribed solvent, thereby forming a coating film, drying the coating film, and then applying pressure so as to achieve a prescribed density and thickness.

Instead of forming a film using this type of mixture slurry, consideration has also been given to Moisture Powder Sheeting (MPS) formed by using a so-called moisture powder, which has a higher proportion of solid components than a mixture slurry, and in which aggregates are formed in such a way that a solvent is held on active material particle surfaces and binder molecule surfaces.

For example, Japanese Patent Application Publication No. 2019-075244 discloses a method for producing an electrode having an electrode active material layer by using a moisture powder. An electrode production apparatus provided with three rollers (a roller A, a roller B and a roller C) is used in the production of this electrode. Specifically, a moisture powder is first supplied to a gap between the roller A and the roller B, and a moisture powder film is formed on the surface of the roller B. Next, the moisture powder film formed on the roller B is transferred to a current collector transported from the roller C. In this transfer, the positions of both edges of the moisture powder film are controlled using two control members (that is, the form of both edges of the coating film is controlled). Next, the electrode active material layer is formed by drying the undried active material layer formed on the current collector.

### SUMMARY

By using control members such as those mentioned above, it is possible to obtain an electrode active material layer in which the form of both edges has been favorably controlled, but this control needs to be more favorably exhibited in cases where electrodes having higher precision are to be produced. Moreover, an explanation has been given above for a case in which a moisture powder is used, but in addition to such a case, this control is also required in, for example, dry powders and mixture slurries prepared so as to have a suitable viscosity.

In view of the circumstances mentioned above, the main purpose of the present disclosure is to provide a method for producing an electrode having an electrode active material layer in which the form of both edges is favorably controlled.

In order to achieve the objective mentioned above, the present disclosure provides a method for producing an electrode which includes a long sheet-shaped electrode current collector of a positive electrode or a negative electrode; and a long sheet-shaped electrode active material layer formed on the electrode current collector. This method for producing an electrode includes the following steps: an electrode material preparation step for preparing an electrode material; a film formation step for forming a coating film in the sheet longitudinal direction on the electrode current collector using the electrode material; and a roller forming step for adjusting the form of both edge parts in the sheet longitudinal direction of the coating film by bringing both edges of a forming roller into contact with a coating film-non-formed part, in which the coating film is not formed on the electrode current collector, and bringing the coating film into contact with the central part of a recessed portion present between contact regions at a prescribed contact pressure.

According to this method for producing an electrode, it is possible to prevent a coating film from leaking onto the electrode current collector and enable the coating film to be compression molded. As a result, it is possible to obtain an electrode active material layer in which the form of both edges is favorably controlled.

In a preferred aspect of the method for producing an electrode disclosed here, a backup roller that faces the forming roller is also present, and when the rotational speed of the forming roller is denoted by A and the rotational speed of the backup roller is denoted by B in the roll forming step, the forming roller and the backup roller are rotated at rotational speeds whereby the rotational speed ratio (A/B) is such that 0.98≤A/B≤1.02. Therefore, such an aspect is preferred from the perspective of being able to prevent breakage of an electrode current collector in advance.

In a preferred aspect of the method for producing an electrode disclosed here, the electrode material contains a moisture powder, and the moisture powder is constituted from aggregated particles containing a plurality of electrode active material particles, a binder resin and a solvent. Here, solid phases, liquid phases and gas phases form a pendular state or a funicular state in at least 50% by number of the aggregated particles that constitute the moisture powder. Details are given later, but using this type of moisture powder as an electrode material is preferred from the perspective of being able to efficiently control the form of both edges of a coating film.

In this preferred aspect, when the bulk specific gravity measured by placing an amount (g) of the moisture powder in a container having a prescribed volume (mL) and then leveling the moisture powder without applying a force is denoted by the loose bulk specific gravity X (g/mL), and the specific gravity calculated from the composition of the moisture powder on the assumption that a vapor phase is not present is denoted by the true specific gravity Y (g/mL), then the ratio of the loose bulk specific gravity X and the true specific gravity Y (Y/X) is 1.2 or more.

In a preferred aspect of the method for producing an electrode disclosed here, the film formation step is carried out by supplying the electrode material between a pair of rotating rollers so as to form a coating film comprising the electrode material on the surface of one of the rollers, and transferring the coating film to a surface of the electrode current collector, which has been transported on the other rotating roller.

In this preferred aspect, when the degree of change in width of the coating film in a direction perpendicular to the sheet longitudinal direction before and after the coating film passes the forming roller is denoted by k, and the void compression rate, which is the degree to which voids present in the coating film are compressed before and after the coating film passes the forming roller is denoted by θ, and the thickness of the coating film after passing the pair of rotating rollers but before passing the forming roller is denoted by T, a forming roller in which the distance H between the contact region and the central part of the recessed portion satisfies the following formula H≤T/(kθ) is used in the roller forming step.

Details are given later, but using this type of forming roller is preferred from the perspective of being able to obtain an electrode active material layer in which the form (form includes shape) of both edges is more favorably controlled.

### BRIEF DESCRIPTION OF THE DRAWINGS

FIG. 1 is a flow chart that shows the general process of an electrode production method according to one embodiment;

FIGS. 2A to 2D are explanatory diagrams that schematically illustrate states in which solid phases (solids such as active material particles), liquid phases (a solvent) and gas phases (voids) are present in an aggregated particle that constitutes the moisture powder, with FIG. 2A showing a pendular state, FIG. 2B showing a funicular state, FIG. 2C showing a capillary state, and FIG. 2D showing a slurry-like state;

FIG. 3 is an explanatory diagram that schematically illustrates an example of a stirring granulator used for producing the moisture powder disclosed here;

FIG. 4 is a block diagram that schematically illustrates the configuration of an electrode production apparatus according to one embodiment;

FIG. 5 is a diagram for explaining the roller forming unit shown in FIG. 4;

FIG. 6 is a diagram in which FIG. 5 is viewed from the P direction;

FIG. 7 is a diagram for explaining a method for deriving the degree of change in width k according to one embodiment;

FIG. 8 is an explanatory diagram that schematically illustrates the configuration of a lithium ion secondary battery according to one embodiment;

FIG. 9 is a cross section SEM image that shows an edge part of a negative electrode active material layer according to Test Example 1; and

FIG. 10 is a cross section SEM image that shows an edge part of a negative electrode active material layer according to Test Example 2.

### DETAILED DESCRIPTION

A detailed explanation will now be given of an electrode production method able to be advantageously used for a lithium ion secondary battery, which is a typical example of a secondary battery, with reference to the drawings as appropriate. Matters other than those explicitly mentioned in the present specification but which are essential for carrying out the disclosure are matters that a person skilled in the art could understand to be matters of design on the basis of the prior art in this technical field. The present disclosure can be carried out on the basis of the matters disclosed in the present specification and common general technical knowledge in this technical field. Moreover, the embodiments explained below are not intended to limit the features disclosed here. In addition, members/parts that perform the same action are denoted by the same symbols in the drawings shown in the present specification. Furthermore, dimensional relationships (length, width, thickness and so on) in the drawings do not reflect actual dimensional relationships.

Moreover, in the specification and claims of the present disclosure, cases where numerical ranges are written as A to B (here, A and B are arbitrary numbers) mean not less than A and not more than B. Therefore, this also encompasses a range that is greater than A and a range that is less than B.

In the present specification, the term “lithium ion secondary battery” means a secondary battery in which movement of charge is borne by lithium ions in an electrolyte. In addition, the term “electrolyte body” means a structure that serves as a primary component of a battery constituted from a positive electrode and a negative electrode. In the present specification, the term “electrode” is used if there is no need to make a particular distinction between a positive electrode and a negative electrode. The term “electrode active material” (that is, positive electrode active material or negative electrode active material) means a compound capable of reversibly storing and releasing chemical species that serve as charge carriers (lithium ions in the case of a lithium ion secondary battery).

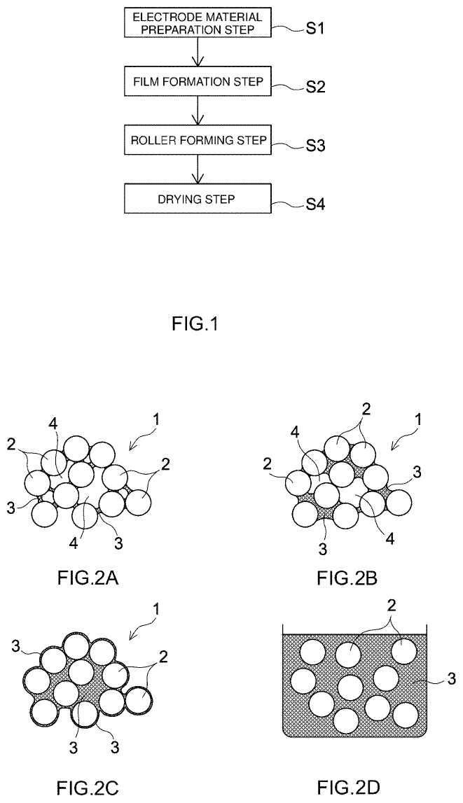

FIG. 1 is a flow chart that shows the general process of an electrode production method according to one embodiment. As shown in FIG. 1, the method for producing an electrode according to the present embodiment has, in general terms, an electrode material preparation step for preparing an electrode material (step S1); a film formation step for forming a coating film in the sheet longitudinal direction on the electrode current collector using the electrode material (step S2); a roller forming step for controlling the form of both edge parts in the sheet longitudinal direction of the coating film by bringing both edges of a forming roller into contact with a coating film-non-formed part, in which the coating film is not formed on the electrode current collector (step S3); and a drying step for drying the coating film after the roller forming step (step S4). Each step will now be explained in detail.

### Step S1

An electrode material is prepared in step S1. Moreover, an explanation is given in the present embodiment of a case in which a moisture powder is used as an electrode material, but the electrode material is in no way limited to this type of material. For example, dry powders and slurry-like (including ink-like and paste-like) electrode materials prepared by mixing an electrode active material, a binder, an electrically conductive material, a solvent, and the like, can be used as the electrode material. Moreover, a case in which a mixed slurry type electrode material is used is preferred because the material can be adjusted to a suitable viscosity, and a highly viscous fluid having a viscosity of approximately 10,000 mPa·s to 30,000 mPa·s (for example, 20,000 mPa·s), as measured using a commercially available viscometer at 25° C. and 20 rpm, can be advantageously used. Moreover, a moisture powder can be advantageously used from the perspective of efficiently controlling the form of both edges of a coating film.

An explanation will now be given of the moisture powder disclosed here. First, the manner in which solid components (solid phases), a solvent (liquid phases) and voids (gas phases) are present in aggregated particles that constitute the moisture powder can be classified into four types, namely “a pendular state”, “a funicular state”, “a capillary state” and “a slurry state”. This classification is described in “Particle Size Enlargement” by Capes C. E. (published by Elsevier Scientific Publishing Company, 1980), and is currently well known. These four classifications are also used in the present specification, and the moisture powder disclosed here is therefore defined in a manner that is clear for a person skilled in the art. Detailed explanations of these four classifications will now be given.

“Pendular state” means a state in which a solvent (a liquid phase) 3 is present in a discontinuous manner between active material particles (solid phases) 2 in an aggregated particle 1, as shown in FIG. 2A, and active material particles (solid phases) 2 can be present in an interlinked (connected) manner. As shown in the figure, the content of the solvent 3 is relatively low, meaning that many voids (gas phases) 4 present in the aggregated particle 1 are present in a connected form and form continuous pores connected to the outside. In addition, an example of a pendular state is one characterized in that a connected layer of solvent is not observed across the entire outer surface of the aggregated particle 1 in electron microscope observations (SEM observations).

In addition, a “funicular state” means a state in which the solvent content in the aggregated particle 1 is higher than in a pendular state and a solvent (a liquid phase) 3 is present in a continuous manner around the periphery of active material particles (solid phases) 2 in the aggregated particle 1, as shown in FIG. 2B. However, because the amount of solvent is still low, active material particles (solid phases) 2 are present in an interlinked (connected) manner, in the same way as in a pendular state. Meanwhile, the ratio of continuous pores connected to the outside is somewhat low relative to the total amount of voids (gas phases) 4 present in the aggregated particle 1, and the ratio of discontinuous isolated voids tends to increase, but the presence of continuous pores can be confirmed. A funicular state falls between a pendular state and a capillary state, and if funicular states are classified into a funicular I state, which is closer to a pendular state (that is, a state in which the amount of solvent is relatively low), and a funicular II state, which is closer to a capillary state (that is, a state in which the amount of solvent is relatively high), a funicular I state encompasses a state in which a connected layer of solvent is not observed at the outer surface of the aggregated particle 1 in electron microscope observations (SEM observations).

A “capillary state” is a state in which the solvent content in an aggregated particle 1 increases, the amount of solvent in the aggregated particle 1 approaches a saturated state, and a sufficient amount of solvent 3 is present in a continuous manner at the periphery of active material particles 2, meaning that the active material particles 2 are present in a discontinuous manner, as shown in FIG. 2C. Almost all voids (gas phases) present in the aggregated particle 1 (for example, 80 vol % of the total void volume) are present as isolated voids due to the increase in the amount of solvent, and the ratio of voids in the aggregated particle decreases. A “slurry state” is one in which active material particles 2 are suspended in a solvent 3, as shown in FIG. 2D, and is a state that cannot be called aggregated particles. Gas phases are essentially absent.

Moisture powder films formed using moisture powders were known in the past, but in conventional moisture powder films, a moisture powder was in a “capillary state” shown in FIG. 2C, in which a liquid phase is continuously formed across the entire powder. Conversely, the moisture powder disclosed here is in a different state from a conventional moisture powder because the gas phase is controlled, and is a moisture powder in which the pendular state or funicular state (and especially the funicular I state) mentioned above is formed. In these two states, active material particles (solid phases) 2 are liquid bridged by a solvent (liquid phases) 3, and at least some of the voids (gas phases) 4 form continuous pores connected to the outside. The moisture powder prepared in the present embodiment is referred to as a “gas phase-controlled moisture powder” for the sake of convenience.

In this type of gas phase-controlled moisture powder, at least 50% by number of the aggregated particles that constitute the moisture powder have the characteristic that solid phases, liquid phases and gas phases form the pendular state or funicular state (and especially the funicular I state) mentioned above. This gas phase-controlled moisture powder preferably has the morphological feature that when electron microscope observations (SEM observations) are carried out, a layer comprising the solvent is not observed across the entire outer surface of aggregated particles in at least 50% by number of the aggregated particles that constitute the moisture powder.

Moreover, a gas phase-controlled moisture powder can be produced using processing for producing a conventional moisture powder having a capillary state. That is, by adjusting the amount of solvent and the formulation of solid components (active material particles, binder resin, and the like) such that the ratio of a gas phase is higher than in conventional moisture powders and specifically such that many voids (continuous pores) connected to the outside are formed the inner part of an aggregated particle, it is possible to produce a moisture powder as an electrode material (an electrode mixture) encompassed by the pendular state and funicular state described above (and especially a funicular I state).

In addition, in order to achieve liquid bridging between active material particles using the minimum amount of solvent, it is preferable for the surface of a powder material being used to exhibit an appropriate degree of affinity for the solvent being used.

A preferred example of a suitable gas phase-controlled moisture powder disclosed here is one in which a three-phase state observed using electron microscope observations is a pendular state or a funicular state (and especially a funicular I state) and in which “the ratio of the loose bulk specific gravity X and the true specific gravity Y (Y/X)” is 1.2 or more, preferably 1.4 or more (and further preferably 1.6 or more) and is 2 or less, the ratio being calculated from the loose bulk specific gravity X (g/mL), which is measured by placing an obtained moisture powder in a container having a prescribed volume (mL) and then leveling the moisture powder without applying a force, and the raw material-based true specific gravity Y (g/mL), which is the specific gravity calculated from the composition of the moisture powder on the assumption that no gas phase is present.

The gas phase-controlled moisture powder (moisture powder) can be produced by mixing an electrode active material, a solvent, a binder resin and other materials such as additives using a conventional well-known mixing apparatus. Examples of this type of mixing apparatus include a planetary mixer, a ball mill, a roller mill, a kneader and a homogenizer.

Here, a compound having a composition used as a negative electrode active material or positive electrode active material of a conventional secondary battery (a lithium ion secondary battery in this case) can be used as the electrode active material. For example, carbon materials such as graphite, hard carbon and soft carbon can be given as examples of the negative electrode active material. In addition, examples of the positive electrode active material include lithium-transition metal composite oxides such as LiNi_{1/3}Co_{1/3}Mn_{1/3}O₂, LiNiO₂, LiCoO₂, LiFeO₂, LiMn₂O₄ and LiNi_{0.5}Mn_{1.5}O₄, and lithium-transition metal phosphate compounds such as LiFePO₄. The average particle diameter (D50) of active material particles, as based on a laser diffraction/scattering method, should be approximately 0.1 μm to 50 μm, and is preferably approximately 1 μm to 20 μm.

Examples of the binder resin include poly (vinylidene fluoride) (PVDF), carboxymethyl cellulose (CMC), styrene-butadiene rubbers (SBR), polytetrafluoroethylene (PTFE) and polyacrylic acid (PAA). The type of binder resin to be used should be suitable for the type of solvent being used. In addition, preferred examples of electrically conductive materials include carbon materials such as carbon nanotubes and carbon black, such as acetylene black (AB). In addition, in cases where a moisture powder is to be used in an application for forming an electrode of a so-called all solid state battery, a solid electrolyte is used. Although not particularly limited, preferred examples thereof include sulfide solid electrolytes containing Li₂S, P₂S₅, LiI, LiCl, LiBr, Li₂O, SiS₂, B₂S₃, ZₘSₙ (here, m and n are positive integers, and Z is Ge, Zn or Ga), Li₁₀GeP₂S₁₂, or the like, as a constituent element.

The solvent is not particularly limited as long as the solvent can advantageously disperse (dissolve) the binder resin. Preferred examples of the solvent include water, N-methyl-2-pyrrolidone (NMP) and butyl butyrate.

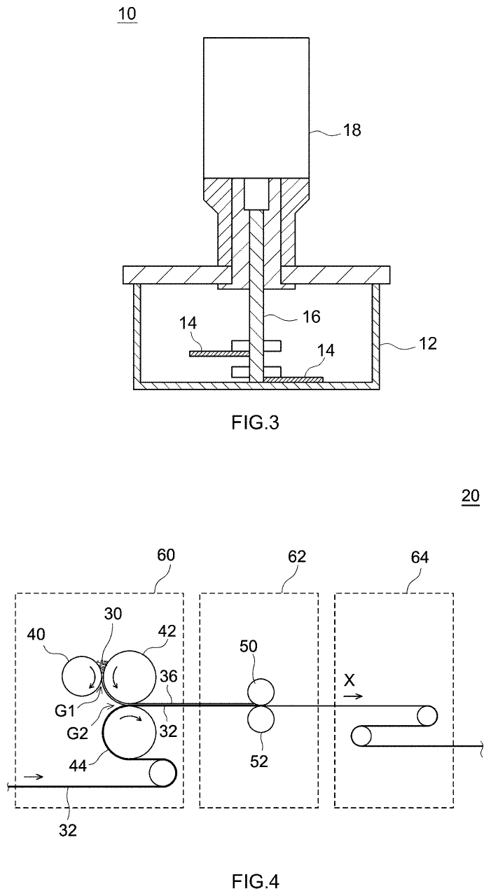

A target gas phase-controlled moisture powder is produced by carrying out wet granulation using materials such as those described above. For example, a target gas phase-controlled moisture powder can be produced by mixing materials using a stirring granulator 10 (a mixer such as a planetary mixer) such as that shown in FIG. 3. As shown in the figure, this type of stirring granulator 10 comprises: a mixing vessel 12 that is typically cylindrical in shape; a rotating blade 14 housed within the mixing vessel 12; and a motor 18 that is connected to the rotating blade (also referred to as a blade) 14 via a rotating shaft 16.

Specifically, an electrode active material and a variety of additives (a binder resin, a thickening agent, an electrically conductive material, and the like), which are solid components, are placed in the mixing vessel 12 of the stirring granulator 10 such as that shown in FIG. 3, and the motor 18 is activated so as to rotate the rotating blade 14 at a rotational speed of, for example, 2000 rpm to 5000 rpm for a period of approximately 1 to 30 seconds, thereby producing a mixture of the solid components. Next, a small amount of solvent is added to the mixing vessel 12 so as to attain a solids content of 55% or more, and preferably 60% or more (for example, 65 to 90%), and the rotating blade 14 is rotated for a further 1 to 30 seconds at a rotational speed of, for example, 100 rpm to 1000 rpm. In this way, the materials and the solvent can be mixed in the mixing vessel 12, and moist granules (a moisture powder) can be produced. Moreover, by continuing to stir for a short period of time of approximately 1 to 5 seconds at a rotational speed of approximately 1000 rpm to 3000 rpm, it is possible to prevent aggregation of the moisture powder.

The particle size of the obtained granules can be greater than the width of gaps (G1, G2) between a pair of rollers in the electrode production apparatus 20 described later. In cases where the width of this gap is approximately 10 μm to 100 μm (for example, 20 μm to 50 μm), the particle size of the granules can be 50 μm or more (for example, 100 μm to 300 μm).

In addition, the gas phase-controlled moisture powder has such a low solvent content that a layer of solvent is not observed at the outer surface of an aggregated particle (for example, the solvent content can be approximately 2 to 15%, or 3 to 8%), but gas phase portions are relatively large. This gas phase-controlled moisture powder can be produced using the processing for producing a moisture powder described above. That is, by adjusting the amount of solvent and the formulation of solid components (active material particles, binder resin, and the like) such that the ratio of gas phases is higher than in the moisture powder mentioned above and specifically such that many voids (continuous pores) connected to the outside are formed in the inner part of an aggregated particle, it is possible to produce a moisture powder as an electrode material encompassed by the pendular state and funicular state described above (and especially a funicular I state). In addition, in order to achieve liquid bridging between active material particles using the minimum amount of solvent, it is preferable for the surface of a powder material being used to exhibit an appropriate degree of affinity for the solvent being used.

### Steps S2 to S4

After preparing the gas phase-controlled moisture powder (moisture powder) as an electrode material using the processing described above (step S1), steps S2 to S4 are carried out. The electrode production apparatus 20 shown in FIG. 4 can be given as an example of a preferred electrode production apparatus for carrying out steps S2 to S4. In general terms, this electrode production apparatus comprises: a film formation unit 60, in which a coating film 36 is formed by supplying a moisture powder 30 to a surface of a sheet-shaped electrode current collector 32 that has been transported from a supply chamber (not shown); a roller forming unit 62 that adjusts the form of both edge parts 37 in the sheet longitudinal direction of the coating film by bringing both edges of a forming roller 50 into contact with a coating film-non-formed part 34, in which the coating film 36 is not formed on the electrode current collector 32, and bringing the coating film into contact with a central part 51b of a recessed portion present between contact regions 51 at a prescribed contact pressure; and a drying unit 64 in which an electrode active material layer is formed by suitably drying the coating film 36 after the roller forming. Each unit will now be explained.

The film formation unit 60 comprises a supply roller 40, a transfer roller 42 and a backup roller 44 for the transfer roller, each of which is connected to an independent driving apparatus (motor), which are not shown. As shown in FIG. 4, the supply roller 40 faces the transfer roller 42, and the transfer roller faces the backup roller 44 for the transfer roller in the film formation unit 60 according to the present embodiment. Because each roller is connected to an independent driving apparatus (motor), each roller can be rotated at a desired rotational speed. For example, it is preferable for the rotational speed of the backup roller 44 for the transfer roller to be faster than the rotational speed of the transfer roller 42 from the perspective of efficiently transferring the coating film 36 to the surface of the electrode current collector 32.

The sizes of the supply roller 40, the transfer roller 42 and the backup roller 44 for the transfer roller are not particularly limited, and may be similar to sizes used in conventional roll-to-roll film formation apparatuses, and can be, for example, diameters of 50 mm to 500 mm. The diameters of these three rotating rollers 40, 42, 44 may be the same as, or different from, each other. In addition, the width at which to form a coating film may be similar to that in a conventional roll-to-roll film formation apparatus, and can be decided, as appropriate, according to the width of an electrode current collector on which a coating film is to be formed. In addition, the materials of the peripheral surfaces of these rotating rollers 40, 42, 44 may be the same as materials used in rotating rollers in well-known conventional roll-to-roll film formation apparatuses, examples of which include SUS steel and SUJ steel.

The roller forming unit 62 is a unit that controls the form of the edge parts 37 in the sheet longitudinal direction X of the coating film 36 applied to the surface of the electrode current collector 32 transported from the film formation unit 60 (that is, a unit that yields a form in which leakage of the coating film onto the coating film-non-formed part 34 is suppressed). As shown in FIG. 4 and FIG. 5, the roller forming unit comprises: a forming roller 50 and, facing this, a backup roller 52 for the forming roller, each of these rollers being connected to an independent driving apparatus (motor), which are not shown. Because each roller is connected to an independent driving apparatus (motor), each roller can be rotated at a desired rotational speed. Here, if the rotational speed of the forming roller 50 is denoted by A and the rotational speed of the backup roller 52 for the forming roller is denoted by B, a case where the rotational speed ratio (A/B) is such that 0.98≤A/B≤1.02 (and more preferably such that 0.99≤A/B≤1.01) is preferred. Therefore, it is possible to prevent breakage of an electrode current collector 32 before it happens.

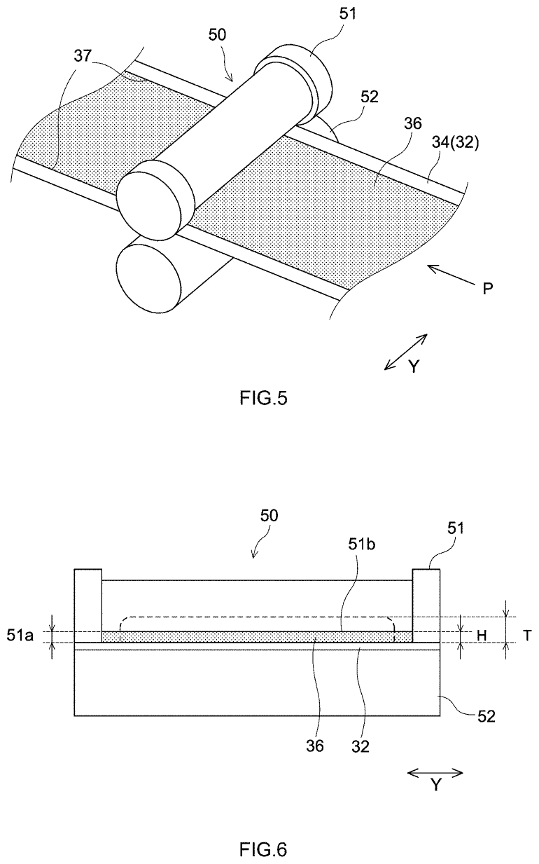

As shown in FIG. 5 and FIG. 6, the forming roller 50 has two contact regions 51. In the roller forming step (step S3), the form of both edge parts 37 in the sheet longitudinal direction X of the coating film is adjusted by bringing the two contact regions 51 into contact with a coating film-non-formed part 34, in which the coating film 36 is not formed on the electrode current collector 32, and bringing the coating film into contact with the central part 51b of a recessed portion present between the contact regions at a prescribed contact pressure. Here, this contact pressure can be, for example, 50 to 200 MPa.

According to this roller forming, it is possible to prevent the coating film 36 from leaking onto the surface of the coating film-non-formed part 34 and enable the coating film to be compression molded. As a result, it is possible to obtain an electrode active material layer in which the form of the edge parts 37 in the sheet longitudinal direction X is favorably controlled.

The size of the contact regions 51 of the forming roller 50 and that of the backup roller 52 for the forming roller are not particularly limited as long as the advantageous effect of the features disclosed here can be achieved, and can be, for example, 50 mm to 500 mm. The diameters of the contact regions 51 and the backup roller 52 for the forming roller may be the same as, or different from, each other. In addition, the material of the peripheral surface of the rollers 50, 52 is not particularly limited as long as the advantageous effect of the features disclosed here can be achieved, and examples thereof include SUS steel and SUJ steel.

Here, the distance H between a contact region 51 and the central part 51b of the recessed part in the forming roller 50 (hereinafter referred to simply as a “step”) can be specified using a preliminary experiment or the like. Specifically, the size of the step H can be taken to be the thickness when the electrode production apparatus 20 is operated and the thickness of the coating film 36 is measured using a commercially available non-contact displacement sensor (two-dimensional sensor) or the like after the coating film passes the transfer roller 42 but before the coating film passes the forming roller 50.

In a preferred aspect, if the degree of change in width of the coating film 36 in a width direction Y perpendicular to the sheet longitudinal direction X before and after the coating film passes the forming roller 50 is denoted by k, the void compression rate, which is the degree to which voids present in the coating film 36 are compressed before and after the coating film passes the forming roller 50 is denoted by θ, and the thickness of the coating film 36 after the coating film passes the transfer roller 42 but before the coating film passes the forming roller 50 is denoted by T, a forming roller in which the step H satisfies the following formula H≤T/(kθ) is used in the roller forming step (step S3). According to a forming roller having such a step, it is possible to bring the coating film 36 into contact with both side walls of a recessed part 51a, and it is therefore possible to more advantageously control the form (form includes shape) of the edge parts 37 of the coating film (see the working examples given below for the effect achieved thereby). Moreover the parameters θ, k and T mentioned above can be specified by carrying out preliminary experiments or the like. Methods for deriving each parameter will now be explained.

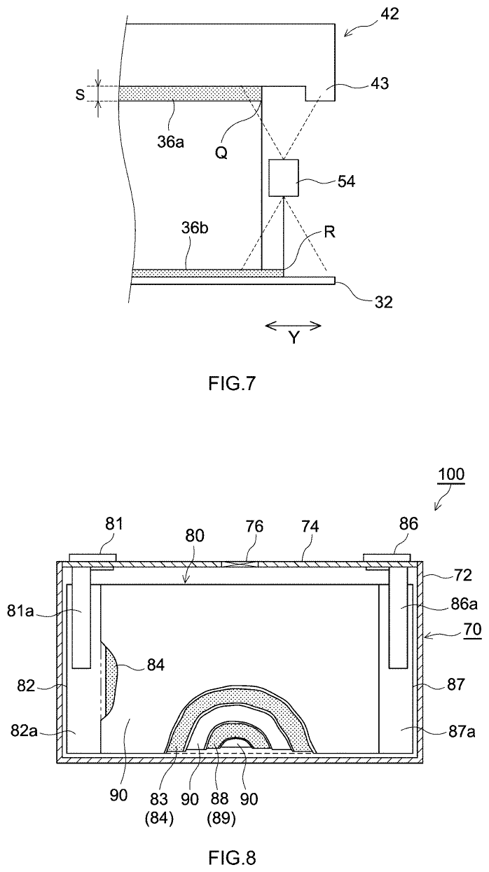

An explanation will first be given of a method for deriving the degree of change in width k, with reference to FIG. 7. As shown in FIG. 7, one end of the transfer roller 42 has a transfer roller step 43.

First, an edge part Q of a coating film 36a present in gaps G1, G2 between rollers and an edge part R of a coating film 36b immediately after passing the forming roller 50 are measured using a two-dimensional sensor 54. Next, the amount of extension in the width direction Y of the coating film 36b (that is, the degree of change in the edge part Q and the edge part R) is calculated. Next, the total width of the coating film 36b in the width direction Y is measured using the two-dimensional sensor 54.

The degree of change in width k can be derived by inputting the thus obtained amount of extension and total width into the following formula: k={(amount of extension×2)/total width}×100 (%). Moreover, the magnitude of this degree of change in width k is not particularly limited as long as the advantageous effect of the features disclosed here can be achieved, but can be approximately 0.5 to 5% (and preferably 0.5 to 2%).

An explanation will now be given of a method for deriving the void compression rate θ. First, the mass per unit weight (g/cm²) of the electrode active material layer is measured after the drying step (step S4). This measurement can be carried out using a conventional well-known method for carrying out such measurements. Next, the thickness (μm) of the electrode active material layer is measured using a two-dimensional sensor or the like. Next, the density (g/cm³) of the electrode active material layer is calculated by dividing the mass per unit area by the thickness of the electrode active material layer.

Next, the estimated mass per unit area (g/cm²) of the coating film 36a on the surface of the transfer roller (see FIG. 7) is calculated by multiplying the mass per unit area of the electrode active material layer by the rotational speed ratio of the transfer roller 42 and the backup roller 44 for the transfer roller (that is, rotational speed of transfer roller 42/rotational speed of backup roller 44 for the transfer roller). The thickness S (μm) of the coating film 36a (see FIG. 7) is then measured using a two-dimensional sensor or the like. Next, the film density (g/cm³) of the coating film is calculated by dividing the estimated mass per unit area by the thickness of the coating film.

The void compression rate θ is derived by inputting the thus obtained electrode active material layer density and coating film density into the following formula: θ=(electrode active material layer density/coating film density)×100 (%). Moreover, the magnitude of this void compression rate θ is not particularly limited as long as the advantageous effect of the features disclosed here can be achieved, but can be approximately 0.5 to 5% (and preferably 0.5 to 3%).

Moreover, the thickness T can be derived by using a two-dimensional sensor or the like to measure the thickness (μm) of the coating film 36 after passing the transfer roller 42 but before passing the forming roller 50.

As shown in FIG. 4, a drying chamber comprising a heater (not shown) is disposed as a drying unit 64 further downstream in the sheet longitudinal direction X than the roller forming unit 62 of the electrode production apparatus 20 of the present embodiment, and this drying chamber dries the coating film 36 on the surface of the electrode current collector 32 transported from the roller forming unit 62. Moreover, this drying unit 64 may be similar to a drying unit used in a conventional electrode production apparatus and does not especially characterize the present disclosure, and further explanations of this drying unit will therefore be omitted.

A long sheet-shaped electrode for a lithium ion secondary battery is produced by drying the coating film 36 and then, if necessary, pressing the coating film at a pressure of approximately 50 to 200 MPa. A sheet-shaped electrode produced in this way can be used as a conventional sheet-shaped positive electrode or negative electrode to construct a lithium ion secondary battery.

### Modifications

An explanation has been given above of an example of the method for producing an electrode disclosed here, but details of the method for producing an electrode disclosed here are not limited to this specific example. The method for producing an electrode disclosed here encompasses a variety of modifications to the specific example described above as long as these do not deviate from the purpose of the present disclosure.

In the embodiments described above, explanations have been given for a method for producing an electrode in which one pair comprising the forming roller 50 and the backup roller 52 for the forming roller is used, but the present disclosure is not limited to this configuration, and an electrode may be produced using, for example, a plurality of these pairs. Such an aspect is preferred from the perspective of being able to more efficiently control the form of both edge parts of the coating film.

In addition, in the embodiments described above, explanations have been given for a method for producing an electrode using a forming roller 50 and a backup roller 52 for the forming roller, but the present disclosure is not limited to this, and it is possible to use, for example, a forming roller instead of the backup roller for the forming roller. That is, roller forming may be performed using two forming rollers. Such an aspect is preferred from the perspective of being able to more efficiently control the form of both edge parts of the coating film in a case where a coating film is formed on both surfaces of an electrode current collector. In addition, a conveyor belt may be disposed instead of the backup roller for the forming roller.

For example, FIG. 8 shows an example of a lithium ion secondary battery 100 having an electrode obtained using the production method according to the present embodiment.

The lithium ion secondary battery (non-aqueous electrolyte secondary battery) 100 of the present embodiment is a battery in which a flat wound electrode body 80 and a non-aqueous electrolyte solution (not shown) are housed in a battery case 70 (that is, an outer container). The battery case 70 is constituted from a box-shaped (that is, a bottomed cuboid) case main body 72 having an opening on one side (corresponding to the top in a normal battery usage configuration) and a lid 74 that seals the opening on the case main body 72. Here, the wound electrode body 80 has a form in which the winding axis of the wound electrode body is turned sideways (that is, the direction of the winding axis of the wound electrode body 80 is approximately parallel to the surface direction of the lid 74), and is housed in the battery case 70 (the case main body 72). For example, a metal material which is lightweight and exhibits good thermal conductivity, such as aluminum, stainless steel or nickel-plated steel, can be advantageously used as the material of the battery case 70.

As shown in FIG. 8, a positive electrode terminal 81 for external connection and a negative electrode terminal 86 for external connection are provided on the lid 74. The lid 74 is provided with an exhaust valve 76, which is set to release pressure when the pressure inside the battery case 70 rises to a prescribed level or more, and an injection port (not shown) for injecting a non-aqueous electrolyte solution into the battery case 70. By welding the lid 74 to the periphery of the opening of the battery case main body 72 in the battery case 70, it is possible to join (tightly seal) the boundary between the battery case main body 72 and the lid 74.

The wound electrode body 80 is obtained by layering (overlaying) a positive electrode sheet 83, in which a positive electrode active material layer 84 is formed in the longitudinal direction on one surface or both surfaces of a long sheet-shaped positive electrode current collector 82 (typically made of aluminum), and a negative electrode sheet 88, in which a negative electrode active material layer 89 is formed in the longitudinal direction on one surface or both surfaces of a long sheet-shaped negative electrode current collector 87 (typically made of copper), with two long separator sheets 90 (typically comprising a porous polyolefin resin) interposed therebetween, and winding in the longitudinal direction.

The flat wound electrode body 80 can be formed into a flat shape by, for example, winding the positive and negative electrode sheets 83, 88, in which an active material layer comprising the moisture powder 30 is formed using the electrode production apparatus 20 described above, and the long sheet-shaped separators 90 in such a way that the cross section forms a round cylindrical shape, and then squashing (pressing) the cylindrical wound body by pressing in a direction that is perpendicular to the winding axis (typically from the sides). By forming this flat shape, the flat wound electrode body can be advantageously housed in the box-shaped (bottomed cuboid) battery case 70. For example, a method comprising winding the positive and negative electrodes and the separators around the periphery of the cylindrical winding axis can be advantageously used as the winding method.

Although not particularly limited, the wound electrode body 80 can be obtained by overlaying such that a positive electrode active material layer-non-forming part 82a (that is, a part in which the positive electrode active material layer 84 is not formed and the positive electrode current collector 82 is exposed) and a negative electrode active material layer-non-forming part 87a (that is, a part in which the negative electrode active material layer 89 is not formed and the negative electrode current collector 87 is exposed) protrude outwards from both edges in the direction of the winding axis, and then winding. As a result, a winding core, which is formed by layering and winding the positive electrode sheet 83, the negative electrode sheet 88 and the separators 90, is formed in the central part of the wound electrode body 80 in the direction of the winding axis. In addition, in the positive electrode sheet 83 and the negative electrode sheet 88, the positive electrode active material layer-non-forming part 82a and the positive electrode terminal 81 (typically made of aluminum) are electrically connected via a positive electrode current collector plate 81a, and the negative electrode active material layer-non-forming part 87a and the negative electrode terminal 86 (typically made of copper or nickel) are electrically connected via a negative electrode current collector plate 86a. Moreover, the positive and negative electrode current collector plates 81a, 86a and the positive and negative electrode active material layer-non-forming parts 82a, 87a can be joined by means of, for example, ultrasonic welding, resistance welding, or the like.

Typically, an electrolyte solution obtained by incorporating a supporting electrolyte in an appropriate non-aqueous solvent (typically an organic solvent) can be used as the non-aqueous electrolyte solution. For example, a non-aqueous electrolyte solution that is a liquid at normal temperature can be advantageously used. A variety of organic solvents used in ordinary non-aqueous electrolyte secondary batteries can be used without particular limitation as the non-aqueous solvent. For example, aprotic solvents such as carbonate compounds, ether compounds, ester compounds, nitrile compounds, sulfone compounds and lactone compounds can be used without particular limitation. A lithium salt such as LiPF₆ can be advantageously used as the supporting electrolyte. The concentration of the supporting electrolyte is not particularly limited, but can be, for example, 0.1 to 2 mol/L.

Moreover, it is not necessary to limit the electrode body to a wound electrode body 80 such as that shown in the figure in order to implement features disclosed here. For example, a lithium ion secondary battery provided with a layered electrode body formed by layering a plurality of positive electrode sheets and negative electrode sheets, with separators interposed therebetween, is possible. In addition, as is clear from technical information disclosed in the present specification, the shape of the battery is not limited to the square shape mentioned above. In addition, the embodiments described above are explained using a non-aqueous electrolyte lithium ion secondary battery, in which an electrolyte is a non-aqueous electrolyte solution, as an example, but the present disclosure is not limited to these embodiments, and the features disclosed here can also be applied to a so-called all solid state battery in which a solid electrolyte is used instead of an electrolyte solution. In such a case, the moisture powder in a pendular or funicular state is configured so as to contain a solid electrolyte as a solid component in addition to an active material.

A battery assembly, in which a case to which a non-aqueous electrolyte solution is supplied and which houses an electrode body is sealed, is generally subjected to an initial charging step. In the same way as with a conventional lithium ion secondary battery, an external power source is connected to the battery assembly between positive and negative electrode terminals for external connection, and initial charging is carried out at normal temperature (typically approximately 25° C.) until the voltage between the positive and negative electrode terminals reaches a prescribed value. For example, it is possible to carry out initial charging at a constant current of approximately 0.1 C to 10 C from the start of charging until the voltage between the terminals reaches a prescribed value (for example, 4.3 to 4.8 V), and then carry out constant current constant voltage charging (CC-CV charging) in which charging is carried out at a constant voltage until the SOC (State of Charge) reaches approximately 60% to 100%.

By subsequently carrying out an aging treatment, it is possible to provide a lithium ion secondary battery 100 that can exhibit good performance. The aging treatment is carried out by means of high temperature aging in which the battery 100 that has been subjected to the initial charging is held in a high temperature region at a temperature of 35° C. or higher for a period of 6 hours or longer (and preferably 10 hours or longer, such as 20 hours or longer). By configuring in this way, it is possible to increase the stability of a SEI (Solid Electrolyte Interphase) film, which can occur at the surface of the negative electrode at the time of initial charging, and lower the internal resistance. In addition, it is possible to increase the durability of a lithium ion secondary battery against high temperature storage. The aging temperature is preferably approximately 35° C. to 85° C. (more preferably 40° C. to 80° C., and further preferably 50° C. to 70° C.). If the aging temperature is lower than the range mentioned above, the advantageous effect of lowering initial internal resistance may not be sufficient. If the aging temperature is higher than the range mentioned above, the electrolyte solution may degrade due to, for example, a non-aqueous solvent or a lithium salt degrading, and internal resistance may increase. The upper limit of the aging time is not particularly limited, but if the aging time exceeds approximately 50 hours, a decrease in initial internal resistance is significantly slower, and there may be almost no change in resistance. Therefore, from the perspective of cost reduction, the aging time is preferably approximately 6 to 50 hours (and more preferably 10 to 40 hours, for example 20 to 30 hours).

The lithium ion secondary battery 100 constituted in the manner described above can be used in a variety of applications. Examples of preferred applications include motive power sources fitted to vehicles such as battery electric vehicles (BEV), hybrid electric vehicles (HEV) and plug in hybrid electric vehicles (PHEV). The lithium ion secondary battery 100 can also be used in the form of a battery pack in which a plurality of batteries are connected in series and/or in parallel.

An explanation will now be given of an example in which the parameters θ, k and T are derived using different methods and the size of the step H in the forming roller is specified. A production apparatus such as that shown in FIG. 4 was used in the test examples given below.

In addition, tests were carried out using a negative electrode, but a similar advantageous effect can of course also be achieved for a positive electrode. Moreover, the examples given below in no way limit the present disclosure to these examples.

### Test Example 1

### Preparation of Negative Electrode Material

A gas phase-controlled moisture powder able to be advantageously used as a negative electrode material was first produced, and a negative electrode active material layer was then formed on a copper foil using the produced moisture powder (negative electrode material).

In the present test example, a graphite powder having an average particle diameter (D50) of 10 μm, as measured using a laser scattering⋅diffraction method, was used as a negative electrode active material, a styrene-butadiene rubber (SBR) was used as a binder resin, carboxymethyl cellulose (CMC) was used as a thickening agent, and water was used as a solvent.

The negative electrode material was produced by placing solid components comprising 98 parts by mass of the graphite powder, 1 part by mass of CMC and 1 part by mass of SBR were placed in a stirring granulator (a planetary mixer or high speed mixer) having a rotating blade, such as that shown in FIG. 3, and then carrying out a mixing and stirring treatment. Specifically, the rotational speed of the rotating blade of the stirring granulator was set to 4500 rpm and a stirring and dispersing treatment was carried out for 15 seconds, thereby obtaining a powder material mixture comprising the solid components mentioned above. Water was added as a solvent to the obtained mixture so as to attain a solids content of 90 mass %, a stirring, mixing and combining treatment was carried out at 300 rpm for 30 seconds, and a stirring and refining treatment was then continued for 2 seconds at a rotational speed of 1000 rpm. A gas phase-controlled moisture powder (negative electrode material) of the present test example was produced in this way.

Next, preliminary experiments for deriving the parameters θ, k and T were carried out using the thus produced gas phase-controlled moisture powder.

First, the total width in the width direction Y of the coating film immediately before passing the forming roller was measured and found to be 210 mm. In addition, the total width in the width direction Y of the coating film immediately after passing the forming roller was measured and found to be 212.5 mm. Therefore, the degree of change in width k=(total width of coating film immediately after passing forming roller)/(total width of coating film immediately before passing forming roller) was calculated to be 1.01.

Next, the thickness T of the coating film immediately before passing the forming roller was measured and found to be 109 μm. In addition, the thickness of the electrode active material layer after the drying step was measured and found to be 107.3 μm. Therefore, the void compression rate θ=(thickness of coating film immediately before passing forming roller)/(thickness of electrode active material layer after drying step) was calculated to be 1.02. Moreover, these measurements were carried out using a commercially available two-dimensional sensor.

A suitable magnitude for the step H of the forming roller was calculated by substituting the parameters θ, k and T in the formula H≤T/(kθ). As a result, it was calculated that the magnitude of the step H was approximately 108 μm or less (for example, 106 μm). The form of both edges of the coating film was controlled using a forming roller having such a step.

### Production of Negative Electrode

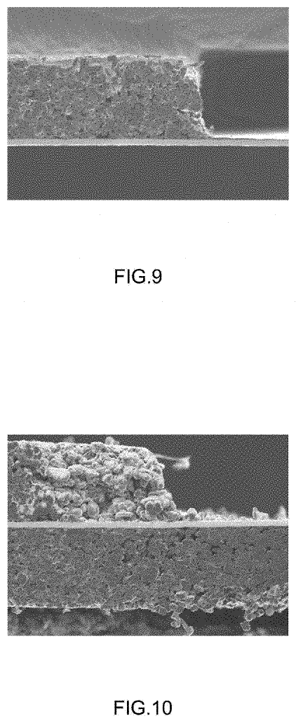

Thus obtained gas phase-controlled moisture powder was supplied to the electrode production apparatus, and the coating film was transferred to the surface of a negative electrode current collector comprising a copper foil that had been transported from a backup roller for a transfer roller. Next, the form of the coating film was controlled by a forming roller in which the size of the step H was defined as mentioned above, and the coating film was then dried, thereby producing a negative electrode according to Test Example 1. FIG. 9 is a cross section SEM image of the negative electrode according to Test Example 1.

### Test Example 2

A negative electrode according to Test Example 2 was produced in the same way as in Test Example 1, except that roller forming was not carried out. FIG. 10 is a cross section SEM image of the negative electrode according to Test Example 2.

As can be understood from the cross section SEM images in FIG. 9 and FIG. 10, it was confirmed the edge parts of the negative electrode active material layer of the negative electrode according to Test Example 1, in which control was carried out using a forming roller having a step H defined as mentioned above, was more favorably controlled in terms of the form (form includes shape) of edge parts than the edge parts of the negative electrode active material layer of the negative electrode according to Test Example 2, in which control using a forming roller was not carried out.

Specific examples of the present disclosure have been explained in detail above, but these are merely examples, and do not limit the scope of the claims. The features set forth in the claims also encompass modes obtained by variously modifying or altering the specific examples shown above.

1. A method for producing an electrode which includes a long sheet-shaped electrode current collector of a positive electrode or a negative electrode and a long sheet-shaped electrode active material layer formed on the electrode current collector, the method comprising:
an electrode material preparation step for preparing an electrode material;
a film formation step for forming a coating film in the sheet longitudinal direction on the electrode current collector using the electrode material; and
a roller forming step for adjusting the form of both edge parts in the sheet longitudinal direction of the coating film by bringing both edges of a forming roller into contact with a coating film-non-formed part, in which the coating film is not formed on the electrode current collector, and bringing the coating film into contact with the central part of a recessed portion present between contact regions at a prescribed contact pressure.

2. The method for producing an electrode according to claim 1, wherein:
a backup roller that faces the forming roller is also present, and
when the rotational speed of the forming roller is denoted by A and the rotational speed of the backup roller is denoted by B in the roller forming step, the forming roller and the backup roller are rotated at rotational speeds whereby the rotational speed ratio (A/B) is such that 0.98≤A/B≤1.02.

3. The method for producing an electrode according to claim 1, wherein:
the electrode material contains a moisture powder, and
the moisture powder is constituted from aggregated particles that contain a plurality of electrode active material particles, a binder resin and a solvent, wherein:
solid phases, liquid phases and gas phases form a pendular state or a funicular state in at least 50% by number of the aggregated particles that constitute the moisture powder.

4. The method for producing an electrode according to claim 3, wherein:
when the bulk specific gravity measured by placing an amount (g) of the moisture powder in a container having a prescribed volume (mL) and then leveling the moisture powder without applying a force is denoted by the loose bulk specific gravity X (g/mL), and
the specific gravity calculated from the composition of the moisture powder on the assumption that no gas phase is present is denoted by the true specific gravity Y (g/mL), then
the ratio (Y/X) of the loose bulk specific gravity X and the true specific gravity Y is 1.2 or more.

5. The method for producing an electrode according to claim 1, wherein:
the film formation step is carried out by supplying the electrode material between a pair of rotating rollers so as to form a coating film comprising the electrode material on the surface of one of the rollers, and transferring the coating film to the surface of the electrode current collector that has been transported on the other rotating roller.

6. The method for producing an electrode according to claim 5, wherein:
when the degree of change in width of the coating film in a direction perpendicular to the sheet longitudinal direction before and after the coating film passes the forming roller is denoted by k, and
the void compression rate, which is the degree to which voids present in the coating film are compressed before and after the coating film passes the forming roller is denoted by θ, and
the thickness of the coating film after passing the pair of rotating rollers but before passing the forming roller is denoted by T,
a forming roller in which the distance H between the contact region and the central part of the recessed portion satisfies the following formula:
H≤T/(kθ)
is used in the roller forming step.
